(19) United States
(12) Patent Application Publication
(10) Pub. No.: US 2015/0136828 A1
(43) Pub. Date: May 21, 2015

(54) QUICK-RELEASE TYPE THREE-IN-ONE PNEUMATIC NAILER

(71) Applicant: Xiao-Rong Li, Taizhou (CN)

(72) Inventor: Xiao-Rong Li, Taizhou (CN)

(73) Assignee: Zhejiang Rongpeng Air Tools Co., Ltd., Taizhou (CN)

(21) Appl. No.: 14/133,644

(22) Filed: Dec. 19, 2013

(30) Foreign Application Priority Data
Nov. 21, 2013 (CN) 201320738342.4

(51) Int. Cl. B25C 1/00; B25C 1/04

(52) U.S. Cl. CPC B25C 1/001; B25C 1/04
USPC 227/130

(57) ABSTRACT

The utility invention discloses a quick-release type three-in-one pneumatic nailer, comprising a body, a handle, a magazine, a loading nails hole arranged on the right side of the magazine and a nailer head in front of the body, is characterized in that: a magazine guide bar fixing in the rear of the magazine, a magazine fixing plate is arranged in the higher part of the front side of the magazine; a snap pin is arranged in the nailer head matched with the magazine fixing plate; an angle adjusting block is fixed in the lower part of the handle; the angle adjusting block in provided with a plurality of slots matched with the magazine guide bar. The quick-release type three-in-one pneumatic nailer of the utility invention, which of the magazine is set to be releasable device by matching chimeric the magazine fixing plate and the pin, the magazine can be shot out different angle of the nail when the magazine guide bar snaps into three different angle of slots, the design is just like three different pneumatic nailers in one piece, it's no longer needs to buy any more pneumatic nailers to meet work needs, easy to use, time-saving and reduce the cost for buying tools.

### FIELD OF THE INVENTION

The utility model relates to a quick-release type three-in-one pneumatic nailer.

### BACKGROUND OF THE INVENTION

So far the pneumatic nailers widely used in decoration industry, furniture manufacture, etc., the shooting angle of nail depend on the angle of the magazine, but generally magazines are non-removable devices, and when the magazine angle is changed, it required adapted nail feeding mechanism to place another angle of the nail. This situation caused the pneumatic nailers on the market mostly are single angle products, far failed to meet the needs of most customers. In the manufacture of furniture, you will need to involve in shooting nails in many different angles, if the nail just placed in single angle, it must be made your work into a corner, and most people bought many different angle's pneumatic nailers to solve this problem, but it has got more troubles and raised more costs.

### CONTENTS OF THE INVENTION

This utility model to solve the technical problem is to the single angle of the current pneumatic nailer, which is not only need to buy every different angle of pneumatic nailers, but also raise the costs.

In order to solve the above problems, the utility model is adopted technical solutions:

The utility model discloses a quick-release type three-in-one pneumatic nailer, comprising a body, a handle, a magazine, a loading nail hole arranged on the right side of the magazine and a nailer head in front of the body, is characterized in that: a magazine guide bar fixing in the rear of the magazine, a magazine fixing plate is arranged in the higher part of the front side of the magazine; a snap pin is arranged in the nailer head matched with the magazine fixing plate; an angle adjusting block is fixed in the lower part of the handle; the angle adjusting block in provided with a plurality of slots matched with the magazine guide bar.

The inner of the magazine is provided with a nail push mechanism, wherein the nail push mechanism includes a head adjustment sheet, a positioning screw, a head seat; the head adjustment sheet being connected by the positioning screw and the head seat; a compression spring is provided between the head adjustment sheet and the head seat; a notch is arranged on the head adjustment sheet; the head seat includes toggle block, which is on the outside of the magazine; a coil spring is arranged in the lower part of the head seat; the magazine is provided with a slide mating with the head seat.

A limited adjustment sheet was connected to nailer head; wherein the nailer head comprises an chamber arranged inside the nailer head; the limited adjustment sheet comprises a long-arm bracket and an short-arm bracket matched with the chamber; the surface of the nailer head is fixedly provided with a reset spring cover, an reset spring is installed in the reset spring cover; the long-arm bracket is positioned below the reset spring; a projecting part is matched with the long-arm bracket arranged above the chamber.

The magazine fixing plate is provided with the narrow width of a caulking groove; wherein the caulking groove is matched with the snap pin; the angle adjusting block is provided with three slots, which are all in different angles, respectively, for 21 degree, 28 degree and 34 degree, and the slot is T-shaped in cross section; the inside of the magazine guide bar is provided with a positioning pin, a spring is arranged above the positioning pin; a positioning hole is arranged at the bottom of the slot matched with positioning pin.

The utility model has the advantages that:

Compared with the prior art, the quick-release type three-in-one pneumatic nailer of the utility invention, which of the magazine is set to be releasable device by matching chimeric the magazine fixing plate and the pin, the magazine can be shot out different angle of the nail when the magazine guide bar snaps into three different angle of slots, the design is just like three different pneumatic nailers in one piece, it's no longer needs to buy any more pneumatic nailers to meet work needs, easy to use, time-saving and reduce the cost for buying tools.

### DESCRIPTION OF FIGURES

FIG. 1 is a front view of the utility model of a quick-release type three-in-one pneumatic nailer.

FIG. 2 is a cross-sectional view of the utility model of a quick-release type three-in-one pneumatic nailer.

FIG. 3 is a partial cross-sectional view of the utility model of a quick-release type three-in-one pneumatic nailer.

FIG. 4 is a schematic view of a nail-pushing mechanism

FIG. 5 is a schematic view of the utility model of a nailer head

FIG. 6 is a schematic view of the utility model of a quick-release type three-in-one pneumatic nailer.

The following specific embodiments with the accompanying drawings and the present invention is further illustrated:

### DETAILED DESCRIPTION

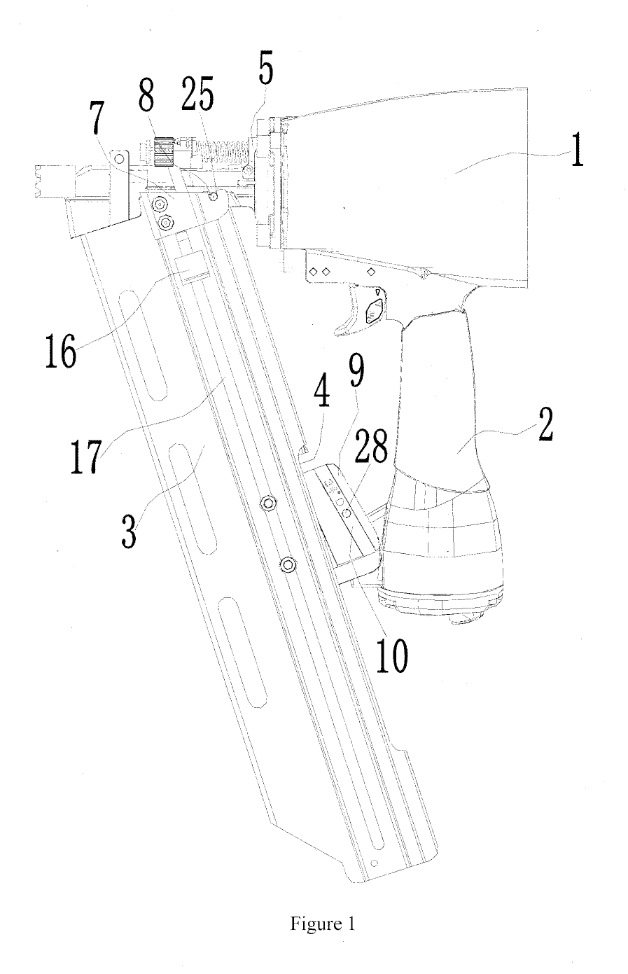

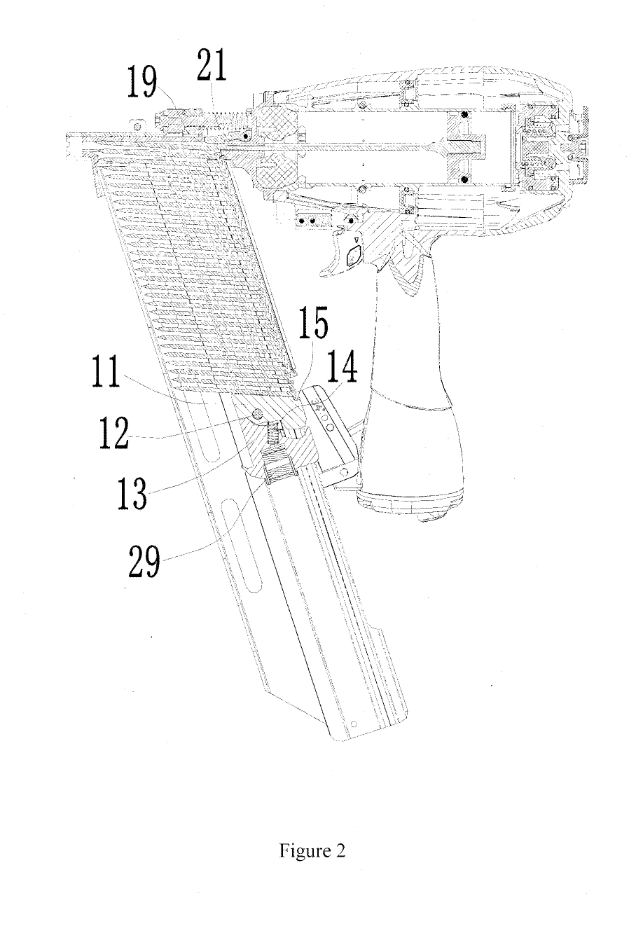

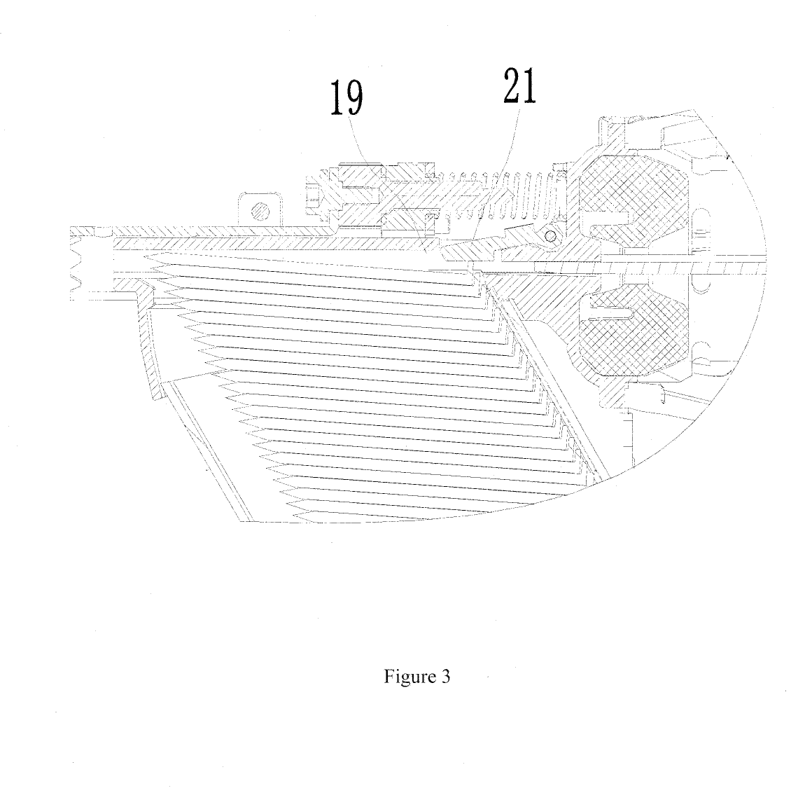

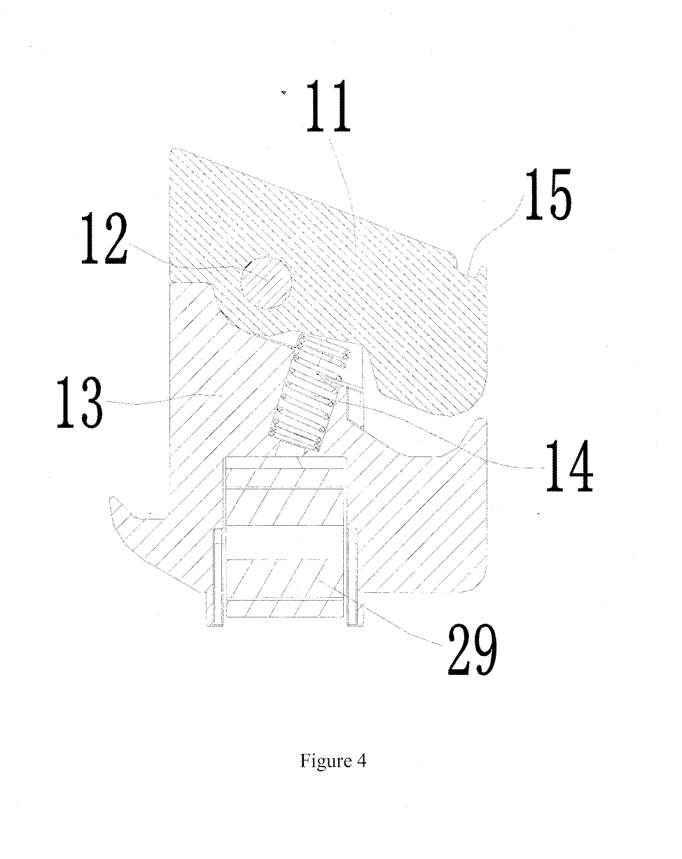

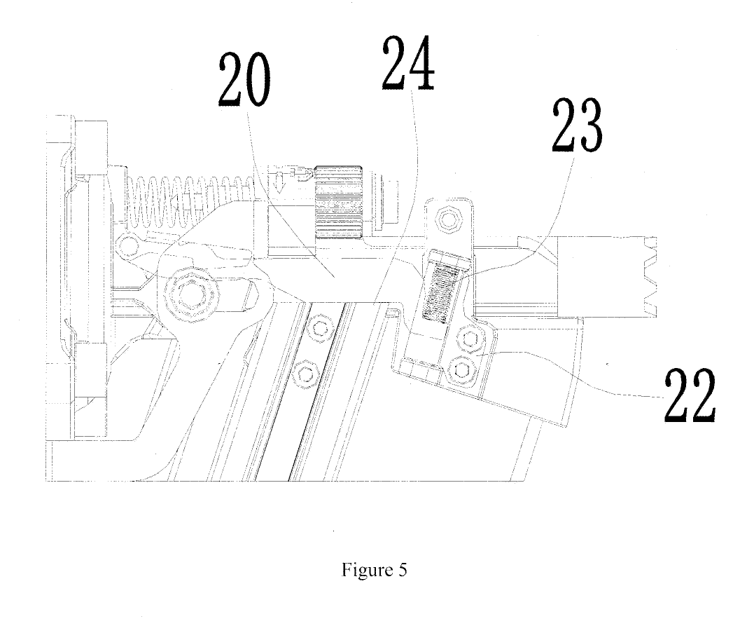

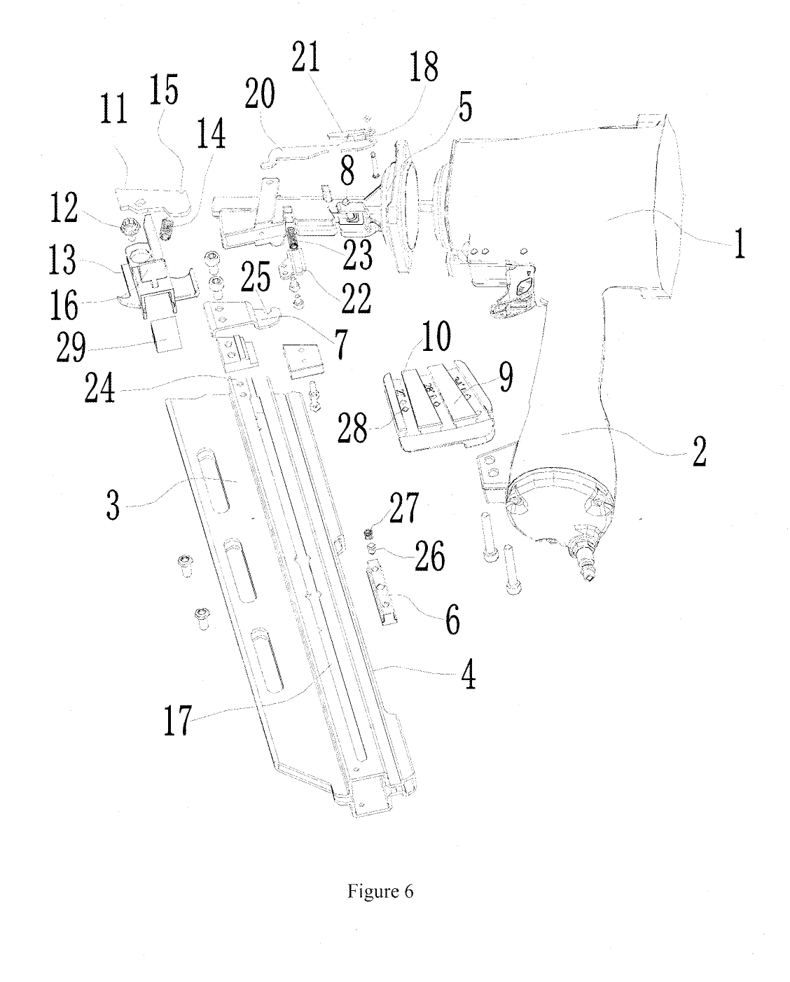

Refer to FIG. 1-6, the utility model provides a quick-release type three-in-one pneumatic nailer, comprising a body (1), a handle (2), a magazine (3), a loading nail hole (4) arranged on the right side of the magazine and a nailer head (5) in front of the body, a magazine guide bar (6) fixing in the rear of the magazine (3), a magazine fixing plate (7) is arranged in the higher part of the front side of the magazine (3); a snap pin (8) is arranged in the nailer head (5) matched with the magazine fixing plate (7); an angle adjusting block (9) is fixed in the lower part of the handle (2); the angle adjusting block (9) in provided with a plurality of slots (10) matched with the magazine guide bar (6).

the inner of the magazine (3) is provided with a nail push mechanism, wherein the nail push mechanism includes a head adjustment sheet (11), a positioning screw (12), a head seat (13); the head adjustment sheet (11) being connected by the positioning screw (12) and the head seat (13); a compression spring (14) is provided between the head adjustment sheet (11) and the head seat (13); a notch (15) is arranged on the head adjustment sheet (11); the head seat (13) includes toggle block (16), which is on the outside of the magazine (3); a coil spring (29) is arranged in the lower part of the head seat (13); the front of the magazine (3) is provided with a slide (17) mating with the head seat (13).

A limited adjustment sheet (18) was connected to nailer head (5); wherein the nailer head (5) comprises an chamber (19) arranged inside the nailer head; the limited adjustment sheet (18) comprises a long-arm bracket (20) and an short-arm bracket (21) matched with the chamber; the surface of the nailer head (5) is fixedly provided with a reset spring cover (22), an reset spring (23) is installed inside the reset spring cover (22); the long-arm bracket (20) is positioned below the reset spring (23); a projecting part (24) is matched with the long-arm bracket (20) arranged above the magazine (3).

the magazine fixing plate (7) is provided with narrow width of a caulking groove (25); wherein the caulking groove (25) is matched with the snap pin (8); the angle adjusting block (9) is provided with three slots (10), which are all in different angles, respectively, for 21 degree, 28 degree and 34 degree, and the slot (10) is T-shaped in cross section; the inside of the magazine guide bar is provided with a positioning pin (26), a spring (27) is arranged above the positioning pin (26); a positioning hole (28) is arranged at the bottom of the slot (10) matched with positioning pin (26).

The utility model is used as follows:

When the nails need to be shot out in one of the 21 degrees, 28 degrees and 34 degree, the magazine guide bar (6) behind the magazine slides into the desired angle of the slot (10), when the positioning pin (26) of the magazine guide bar (6) passed the bottom of the positioning hole (28), the spring (27) above the positioning pin (26) snap into the positioning hole (28) by using elastic force, meanwhile, the magazine fixing plate (7) arranged above the front side of the magazine (3) being contacted by the pin (8), the snap pin (8) snap into the caulking groove (25) in the case of the human force, since the caulking groove (25) is a narrow width shape, the snap pin (8) not easy to fall off from the caulking groove (25) and also can ensure the magazine (3) stable.

After the magazine (3) fixed in one angle, pushing down the toggle block of the head seat, the coil spring (29) arranged below the head seat is been pulled in the same time, the nail pushing mechanism moved down along the slide (17), then the operator load arranging nails into the loading nail hole (4) located in the right side of the magazine, at this point, releasing the toggle block (16) makes nail pushing mechanism move upward by the bounce back force of the coil spring (29) until the head adjustment sheet (11) of the nail pushing mechanism pressing against the bottom of the nails, at the moment, the nail cap of the nails which is contacted with the head adjustment sheet (11) is stuck in the notch (15), the compression spring (14) is arranged between the head adjustment sheet (11) and the head seat (13) for the nail pushing mechanism be able to adapt different angles of arranging nails, since the compression spring (14) can be able to make nail pushing mechanism adapted to any different angles, the position of the head adjustment sheet (11) don't need to be adjusted.

When the magazine (3) was in different angle, the specifications of the nail of the arranging nails will also change, if the magazine is in 21 degrees, the loading nails will be the lager round head nail; if the magazine is in 28 or 34 degrees, the loading nails will be the smaller half-round head nail, due to io different sizes in the fixed chamber (19), it is possible to push more than one nails in firing pin, to prevent this condition, the utility model is provided with the limited adjustment sheet (18), when the angle of the magazine was changed, the contact condition between the projecting part (24) above the magazine and the long-arm bracket (20) will be differently; if the magazine guide bar (6) push into the 21 degrees of the slot (10), the projecting part (24) of the magazine will not contact with the long-arm bracket (20); if the magazine guide bar (6) push into the 28 or 34 degrees of the slot (10), the projecting part (24) of the magazine will contact with the long-arm bracket (20), at which the long-arm bracket (20) was jacked up by the projecting part (24), due to the limited adjustment sheet (18) connected to nailer head (5), the long-arm bracket (20) was jacked up by the pressure, the reset spring (23) arranged inside the reset spring cover (22) give the long-arm bracket (20) a downward force at the moment, the two force made the long-arm bracket (20) in a stable condition and also changed the position of the short-arm bracket (21) matched with the chamber (19) for 28 or 34 degrees of the arranging nails, so the proper nail pushing angle can be adjusted automatically by the contact between the projecting part (24) and the long-arm bracket (20).

What is claimed is:

1. A quick-release type three-in-one pneumatic nailer, comprising a body, a handle, a magazine, a loading nail hole arranged on the right side of the magazine and a nailer head in front of the body, is characterized in that: a magazine guide bar fixing in the rear of the magazine, a magazine fixing plate is arranged in the higher part of the front side of the magazine; a snap pin is arranged in the nailer head matched with the magazine fixing plate; an angle adjusting block is fixed in the lower part of the handle; the angle adjusting block in provided with a plurality of slots matched with the magazine guide bar.

2. The quick-release type three-in-one pneumatic nailer as set forth in claim 1, is characterized in that: the inner of the magazine is provided with a nail push mechanism, wherein the nail push mechanism includes a head adjustment sheet, a positioning screw, a head seat; the head adjustment sheet being connected by the positioning screw and the head seat; a compression spring is provided between the head adjustment sheet and the head seat; a notch is arranged on the head adjustment sheet; the head seat includes toggle block, which is on the outside of the magazine; a coil spring is arranged in the lower part of the head seat; the front of the magazine is provided with a slide mating with the head seat.

3. The quick-release type three-in-one pneumatic nailer as set forth in claim 1, is characterized in that: a limited adjustment sheet was connected to nailer head; wherein the nailer head comprises an chamber arranged inside the nailer head; the limited adjustment sheet comprises a long-arm bracket and an short-arm bracket matched with the chamber; the surface of the nailer head is fixedly provided with a reset spring cover, an reset spring is installed in the reset spring cover; the long-arm bracket is positioned below the reset spring; a projecting part is matched with the long-arm bracket arranged above the magazine.

4. The quick-release type three-in-one pneumatic nailer as set forth in claim 1, is characterized in that: the magazine fixing plate is provided with narrow width of a caulking groove; wherein the caulking groove is matched with the snap pin; the angle adjusting block is provided with three slots, which are all in different angles, respectively, for 21 degree, 28 degree and 34 degree, and the slot is T-shaped in cross section; the inside of the magazine guide bar is provided with a positioning pin, a spring is arranged above the positioning pin; a positioning hole is arranged at the bottom of the slot matched with positioning pin.
